(19) United States
(12) Patent Application Publication
(10) Pub. No.: US 2024/0255380 A1
(43) Pub. Date: Aug. 1, 2024

(54) METHODS FOR DETERMINING THE CYCLOSTATIONNARITY OF A VIBRATION SIGNAL RELATING TO A MECHANICAL SYSTEM, FOR ARRANGING VIBRATION SENSORS FOR MONITORING SUCH A SYSTEM, AND FOR MONITORING IT

(71) Applicant: AIRBUS HELICOPTERS, Marignane Cedex (FR)

(72) Inventors: Hervé MOREL, Aix En Provence (FR); Jérémy JOUVE, Senas (FR); Anas HAD, Roanne (FR); Hugo ANDRE, Roanne (FR); Mohamed EL BADAOUI, Riorges (FR)

(73) Assignee: AIRBUS HELICOPTERS, Marignane Cedex (FR)

(21) Appl. No.: 18/399,847

(22) Filed: Dec. 29, 2023

(30) Foreign Application Priority Data
Jan. 30, 2023 (FR) 2300839

(51) Int. Cl. G01M 13/028

(52) U.S. Cl. CPC G01M 13/028

(57) ABSTRACT

A method for determining the cyclostationarity of a vibration signal transmitted by a vibration sensor arranged on a mechanical system and allowing a cyclostationarity indicator I_{α} to be calculated. The present disclosure also relates to a method for arranging vibration sensors, using the method for determining cyclostationarity applied to the signals transmitted by these vibration sensors at different positions and orientations. A position of a vibration sensor is validated as a function of this cyclostationarity indicator I_{α}. The present disclosure finally relates to a method for monitoring a mechanical system 10 using the method for determining cyclostationarity to determine the cyclostationarity of the vibration signals relating to the mechanical system before calculating the monitoring indicators of the mechanical system.

### CROSS REFERENCE TO RELATED APPLICATIONS

This application claims priority to French patent application No. FR 23 00839 filed on Jan. 30, 2023, the disclosure of which is incorporated in its entirety by reference herein.

### TECHNICAL FIELD

The present disclosure lies in the field of systems for monitoring the operation of mechanical systems, in particular mechanical systems comprising at least one rotating member.

The present disclosure relates to a method and a device for determining the cyclostationarity of a vibration signal relating to a mechanical system comprising a rotating member.

The present disclosure also relates to a method and a device for arranging vibration sensors on a mechanical system comprising at least one rotating member.

The present disclosure finally relates to a method and a device for monitoring a mechanical system comprising at least one rotating member. This monitoring method and device may, for example, apply to the monitoring of a power transmission mechanism arranged between at least one heat engine or electric motor and at least one rotor of an aircraft.

### BACKGROUND

Such a mechanical system comprises at least one rotating member, for example an input shaft and/or an output shaft. For the sake of simplification, a mechanical system comprising at least one rotating member is referred to hereinafter as a “mechanical system”.

For example, a mechanical system may comprise one or more bearings for guiding one or more rotating members in rotation. A bearing comprises, for example, a rolling bearing provided with one or more rows of rolling elements such as balls, rollers or the like.

Such a mechanical system may be provided with at least one toothed wheel, pinion or toothed ring gear in order to reduce or increase the speed of rotation between two rotating members of the mechanical system, in particular between an input shaft and an output shaft.

Such a mechanical system may, for example, be provided with an epicyclic gear train providing a high rotational speed reduction ratio between two rotating members of the mechanical system.

Such a mechanical system may, for example, be a transmission or a gearbox of a vehicle, in particular an aircraft.

A failure or malfunction in such a such a mechanical system may arise, for example, following the occurrence of a fault in a bearing, in particular a rolling bearing, and/or in a toothed wheel, pinion or toothed ring gear. Such a fault may, for example, be in the form of a crack, spall, fracture or even breakage in a toothed wheel, pinion, toothed ring gear or bearing. Such a fault may also be in the form of a rolling element seizing up.

Some monitoring systems, known as Health and Usage Monitoring Systems or HUMS, are designed to monitor one or more mechanical systems, using various sensors to track changes in a set of monitoring indicators. These monitoring indicators are calculated from measurements taken by one or more sensors in order to characterize the state and operation of each mechanical system. For example, a monitoring indicator may be defined by a signal supplied by one sensor or by combining signals from several sensors. Several monitoring indicators may also make use of the measurements from one and the same sensor by taking into account various characteristics of the signal supplied by this sensor, such as its time or frequency spectrum.

Changes in each monitoring indicator may be compared with a detection threshold in order to detect or anticipate a possible fault or failure in the mechanical system that is being monitored. The value of each detection threshold may be obtained by experience, by statistical analysis of a history of measurements from several similar mechanical systems or by individual learning on a given mechanical system.

A monitoring indicator may be in the form of a vibration indicator evaluated using a sensor comprising at least one accelerometer, tachometer or strain gauge, for example. Such a monitoring indicator may in this case be equal to the maximum amplitude of a temporal vibration signal supplied by an accelerometer, for example.

The processing of these signals is described, for example, in the publication “Investigation of effectiveness of some vibration-based techniques in early detection of real-time fatigue failure in gears” by Hasan Ozturk, Isa Yesilyurt and Mustafa Sabuncu (Shock and vibration 12-2010-741-747).

Document EP 3 531 098 discloses a method for monitoring and detecting damage in at least one rotationally movable part of a rotating mechanism of an aircraft. This method uses at least one vibration sensor secured to a fixed casing of the aircraft and arranged in the vicinity of the rotating mechanism in order to measure accelerations in at least one direction and generate a temporal vibration signal. At least one measuring component is used to measure an angular position of each movable part.

For a signal expressed in the time domain, an indicator may be determined from statistical functions such as the root mean square, the peak factor, the skewness or the kurtosis of a distribution, for example.

For a signal varying in the frequency domain, an indicator may be determined from the mean frequency or from the standard deviation frequency.

Other indicators can be constructed from time and frequency decompositions of the signal such as the wavelet transform, empirical mode decomposition or the Short-Time Fourier Transform, for example.

Most of these indicators are calculated from pre-processing operations carried out on a raw signal measured by a sensor in order to eliminate or significantly reduce the noise and/or fluctuations in the speed of the components being monitored. Among these pre-processing operations, such as angular resampling, signal filtering by calculating an average over several cycles or periods may also be used, the aim being to attenuate certain components of the raw signal such as, for example, a random component and/or noise.

The publication “Aide à l'interprétation des signaux cyclostationnaires” by F. Bonnardot, A. Al Zohbi, M. El Badaoui and F. Guillet (CNR'IUT, Tarbes, 2003) describes, for example, the analysis of vibration signals that vary according to the angular position of a rotationally movable part and the use of statistical calculations in order to deduce the periodicity of these signals according to the angle of the movable part and, therefore, the cyclostationarity of these signals. The synchronous mean and the synchronous variance are monitoring signals used to determine the cyclostationarity of vibration signals.

The publication “Extraction of tacho information from a vibration signal for improved synchronous averaging”, by M. D. Coats, N. Sawalhi and R. B. Randall (Annual Conference of the Australian Acoustical Society 2009—Acoustics 2009: Research to Consulting, pages 187-194, 2009) discloses an analysis of a rotating shaft, in particular a shaft of a gas turbine, by means of a tachometer coupled to an auxiliary shaft via a gearbox with an unknown speed reduction ratio.

The publication “Self-running bearing diagnosis based on scalar indicator using fast order frequency spectral coherence” by Kass Souhayb et al (XP085662099, February 2019) describes a method for diagnosing a ball bearing in order to identify a fault, by using the cyclostationarity of a vibration signal supplied by a sensor. This method uses the transformation of this temporal vibration signal into an angular signal, then the calculation of a cyclostationarity indicator.

The publication “Indicators of cyclostationarity: Theory and application to gear fault monitoring” by Raad et al (XP022423344, January 2008) describes the use of cyclostationarity indicators of order 1 to 4 applied to vibration signals in order to diagnose the presence of a fault in a mechanical system by acquiring a temporal vibration signal and transforming it into an angular signal. A cyclostationarity indicator relating to this angular signal is calculated and compared to a threshold in order to determine whether or not there is a fault.

The publication “Cyclic spectral analysis of rolling-element bearing signals: Facts and fictions” by Antoni et al (XP022083965, May 2007) describes the application of a cyclostationarity indicator to a spectral (frequential) vibration signal established by transformation of a temporal vibration signal.

The publication “Application of order cyclostationary demodulation to damage detection in a direct-driven wind turbine bearing” by Xiaofeng Liu et al (XP020257048, December 2013) describes the application of a cyclostationarity indicator to an angular vibration signal established by transformation of a temporal vibration signal, and comparing it to a threshold.

The publication “Cyclostationarity by examples” by Antoni et al (XP025928931, May 2009) describes the application of cyclostationarity to a spectral signal, in a general manner, and on the basis of several examples.

The publication “Statistical Tests for Presence of Cyclostationarity” by A. V. Dandawate et al (XP002381419, September 1994) describes statistical tests for establishing the cyclostationarity of a temporal or angular signal.

Moreover, in the context of vibration monitoring of a mechanical system, the location of the sensors used and their direction of measurement are important, or even essential, in order to allow reliable and effective fault detection. Indeed, a sensor can take measurements in one or more preferred directions. The orientation of these preferred directions, and therefore the sensor, in relation to a reference frame of the mechanical system, may therefore affect the accuracy and the reliability of the measurements taken by the sensor.

However, the location and orientation of a sensor can be considered to be optimal after preliminary tests during the development of a mechanical system, without guaranteeing that the sensor will achieve similar results during use. Indeed, the signal measured and transmitted by the sensor may be sensitive to parameters that vary during certain phases of operation of the mechanical system, and in particular during certain flight phases of an aircraft, or indeed following maintenance interventions.

The aim of the present disclosure is therefore to propose a method and a device intended to analyze a vibration signal relating to a mechanical system comprising a rotating member and to determine, in an alternative manner, the risk of presence of a fault in this mechanical system.

The aim of the present disclosure is also to propose a method and a device intended to optimize the positioning and orientation of vibration sensors on such a mechanical system by using this analysis.

The aim of the present disclosure is finally to propose an alternative method and device intended to monitor a mechanical system comprising a rotating member in order to detect, as soon as possible, the occurrence of a fault following such an analysis of a vibration signal relating to this mechanical system.

### SUMMARY

An object of the present disclosure is, first and foremost, a method for determining the cyclostationarity of a vibration signal relating to a mechanical system, the mechanical system comprising at least one rotating member that rotates about a rotation axis AX and at least one vibration sensor transmitting a temporal vibration signal s(t), an angular sensor transmitting a temporal angular signal θ(t) that varies as a function of an angular position of the rotating member about the rotation axis AX, and a calculator.

The vibration sensor or sensors make it possible to measure characteristics, such as vibrations, for example, of the mechanical system as a whole or of one or more of its components, and to transmit a temporal vibration signal, i.e., a vibration signal in the time domain, carrying information relating to these characteristics, to the calculator, for example. The angular sensor makes it possible to measure an angular position of the rotating member about the rotation axis AX, in relation to a reference of mechanical system, for example a frame or a casing of the mechanical system, and to transmit a temporal angular signal, i.e., an angular signal in the time domain, carrying information relating to this angular position.

Such a mechanical system may comprise at least one of the following elements: at least one rotating member such as an input shaft and/or an output shaft, a rotational guide bearing and, i.e., a rolling bearing provided with rolling elements, a toothed wheel, a pinion or a toothed ring gear. Such a mechanical system may, for example, be a transmission or a gearbox of a vehicle.

The method according to the disclosure comprises the following steps:
transforming the temporal vibration signal s(t) into an angular vibration signal s(θ), using the calculator, as a function of the temporal angular signal θ(t);
calculating a normalized cyclostationarity indicator I_{α}, using the calculator, with a statistical hypothesis test and as a function of the angular vibration signal s(θ); and
determining that the angular vibration signal s(θ) is cyclostationary when the cyclostationarity indicator I_{α} is greater than or equal to a predetermined cyclostationarity threshold, the predetermined cyclostationarity threshold being between 0 and 1.

A vibration sensor, in the context of the disclosure, may, for example, comprise an accelerometer, a tachometer, an encoder-type sensor measuring an angular position of a shaft, a strain gauge or the like. Such a vibration sensor makes it possible to measure temporal vibration signals, comprising, for example, acceleration signals or speed signals. Such a vibration sensor may be positioned at different positions and in various orientations in the mechanical system. Such a vibration sensor may preferably be positioned in the vicinity of a rotating member, for example in the vicinity of an input or output shaft, or a specific element to be monitored, such as a bearing, toothed wheel, pinion or toothed ring gear, for example. The vibration sensor can thus transmit a temporal vibration signal s(t) carrying information relating to the vibrations detected over time.

“Position” should be understood to mean the location where the vibration sensor is arranged in the mechanical system. “Orientation” should be understood to mean the angles of one or more preferred directions of measurement of the vibration sensor.

The angular sensor may be positioned in the vicinity of the rotating member whose angular position it is required to measure. The angular sensor can thus transmit a temporal angular signal θ(t) carrying information relating to the variation in this angular position over time.

The temporal vibration signal s(t) and the temporal angular signal θ(t) may be signals formed by raw measurements transmitted respectively by the vibration sensor and the angular sensor or by measurements obtained relatively complex processing of signals carried out by the calculator or by a calculator integrated into the corresponding sensor on such raw measurements, for example via conventional filtering or sampling, or the application of transformations.

The temporal vibration signal and the temporal angular signal may be transmitted simultaneously or in a synchronized manner.

The temporal vibration signal s(t), i.e., a signal varying in the time domain and therefore as a function of time, is transformed in a known manner into an angular vibration signal s(θ), i.e., a signal varying in an angular domain, as a function of the angular position of the rotating member in question in relation to a reference of the mechanical system. This transformation comprises, for example, angular resampling of the temporal vibration signal s(t) in the angular domain, and is carried out by the calculator using the temporal vibration signal s(t) and the temporal angular signal θ(t).

This transformation of the temporal vibration signal from the time domain to the angular domain advantageously makes it possible to associate the variations of the vibration signal with the angular positions of the rotating member of the mechanical system, and therefore with positions of the elements of the mechanical system. This transformation makes it possible, in particular, to extract periodic statistical properties for the vibration signals displaying speed fluctuations. Indeed, the speed of rotation of the rotating member is not systematically constant, in particular during transient phases, for example when the mechanical system is being started up or during changes in operating mode and in the event of the mechanical system being subjected to heavy loads. Moreover, in a continuous operating mode, the instantaneous speed of rotation of the rotating member may fluctuate slightly and, as a result, in the time domain, the signal is not strictly periodic, whereas in the angular domain, it may be and its cyclostationary characteristics can be evaluated.

Therefore, generally, a signal in the time domain that displays constant statistical properties is said to be “stationary”. A signal in the angular domain that displays periodic statistical properties is said to be “cyclostationary”. In particular, a signal in the angular domain is cyclostationary of order n if the n first statistical moments of order n exist and are periodic. A cyclostationary signal may, for example, comprise a combination of periodic deterministic signals and one or more random phenomena.

Moreover, many faults that occur in a mechanical system, and in particular in a rotating member, a gear or a bearing, are characterized by the appearance of a significant cyclostationary component in a vibration signal of this mechanical system. Conversely, a vibration signal that is only stationary, i.e., that does not comprise a cyclostationary component, may be considered to be a strong indication of the absence of a fault in a rotating member, gear or bearing of the mechanical system.

The cyclostationarities of orders 1 and 2 are particularly interesting when seeking faults in a mechanical system. The cyclostationarity of order 1 denoted by the acronym “CS1” is particularly suited to the specific monitoring of gears, such as toothed wheels, pinions or ring gears, and rotating shafts. The cyclostationarity of order 2 denoted by the acronym “CS2” is particularly suited to the specific monitoring of bearings and, for example, rolling bearings. Furthermore, a complex fault may give rise to the simultaneous occurrence of cyclostationarities of orders 1 and 2.

With this in mind, the method according to the disclosure can be used to calculate a cyclostationarity indicator I_{α} relating to the angular vibration signal s(θ), using the calculator. This cyclostationarity indicator I_{α} is determined using a statistical hypothesis test and is normalized i.e., between 0 and 1.

Therefore, a cyclostationarity indicator I_{α} equal to 0, either of order 1 or of order 2, may mean the almost total absence of a cyclostationarity component of the same order as that of the indicator I_{α} in the angular vibration signal s(θ). A cyclostationarity indicator I_{α} equal to 1, either of order 1 or of order 2, may mean the almost certain presence of cyclostationarity components of the same order as that of the indicator I_{α} in the angular vibration signal s(θ).

However, it should be noted that the almost certain presence of cyclostationarity components in the angular vibration signal s(θ) does not always indicate the presence of a fault. Indeed, although the presence of a fault causes cyclostationary components to other appear, may phenomena also cause cyclostationary components to appear in the angular vibration signal s(θ). During both steady-state operating modes and transient operating modes, the appearance of cyclostationary components may be due to fluctuations in certain parameters of the mechanical system such as the torque of a rotating member or the load connected to the mechanical system.

Therefore, the method for determining the cyclostationarity of a vibration signal according to the disclosure is not a substitute for a fault detection method, but only makes it possible to determine the presence of cyclostationary components likely to be caused by the occurrence of a fault in the mechanical system.

Next, the cyclostationarity indicator I_{α} is compared to a predetermined cyclostationarity threshold between 0 and 1. This cyclostationarity threshold may have been predetermined following tests, for example on fault-free mechanical systems and on mechanical systems with faults, or simulations. This cyclostationarity threshold reflects the conditions under which a vibration signal can be considered to be cyclostationary.

An angular vibration signal s(θ) is considered to be cyclostationary of the same order as that of the indicator I_{α} when the cyclostationarity indicator I_{α} is greater than or equal to the cyclostationarity threshold. Conversely, the angular vibration signal s(θ) may be considered to be non-cyclostationary when the cyclostationarity indicator I_{α} of order 1 and the cyclostationarity indicator I_{α} of order 2 are less than the cyclostationarity threshold.

Therefore, the present disclosure makes it possible, before determining a monitoring indicator, to check, by means of the cyclostationarity indicator I_{α}, the presence of a significant cyclostationary component in the temporal vibration signal s(t) transmitted by the vibration sensor of the mechanical system, that may possibly be a first sign of the risk of a fault occurring in the mechanical system.

The method according to the disclosure may comprise one or more of the following features, taken individually or in combination.

According to one example, the method according to the disclosure may comprise at least one additional step of generating a cyclostationarity alert or generating a non-cyclostationarity alert.

Therefore, during the generation of a cyclostationarity alert, a cyclostationarity alert is generated when the cyclostationarity indicator I_{α} is greater than or equal to the cyclostationarity threshold, whereas, during the generation of a non-cyclostationarity alert, a non-cyclostationarity alert is generated when said cyclostationarity indicator I_{α} is less than said cyclostationarity threshold.

The cyclostationarity and non-cyclostationarity alerts may be audio, visual or indeed haptic. In this way, an operator of the mechanical system can be informed of the cyclostationarity or non-cyclostationarity of the vibration signal.

As a result, the operator knows, if the vibration signal is cyclostationary, that there is a potential risk of presence of a fault in the mechanical system, and the operator can then, for example, initiate a method for monitoring the mechanical system and/or detecting faults in order to confirm or rule out this risk.

Conversely, in the event of non-cyclostationarity of the vibration signal, i.e., in the absence of a cyclostationary component of order 1 and a cyclostationary component order 2, the operator knows that the risk of presence of the specific fault of interest is low, or even non-existent, and the operator can use the mechanical system in complete safety with regard to the risk arising from the occurrence of the specific fault of interest.

According to another example compatible with the preceding examples, the method is intended determine cyclostationarity of order 1, and the statistical hypothesis test is Student's test applied to an estimate \hat{m}(θ) of a synchronous mean of the angular vibration signal s(θ) in relation to a cyclic period Φ and the calculation of a cyclostationarity indicator I_{α} comprises an intermediate step of determining a statistical indicator η_{α}(θ) calculated according to the following relationship:

$${η}_{α} ( θ ) = {t}_{α}^{K - 1} \cdot \frac{\hat{σ} ( θ )}{\sqrt{K}} ,$$

wherein t_{α}^{K-1} is half of a confidence interval associated with Student's test with K−1 degrees of freedom with a risk 1−α;
   \hat{σ}(θ) is an estimate of the standard deviation of the angular vibration signal s(θ) corresponding to a normal distribution for an angle θ defined such that

$$\hat{σ} ( θ ) = \sqrt{( θ ) \cdot \frac{K}{K - 1}} ;$$

θ is the angular position of the rotating member about the rotation axis AX;
[symbol] (θ) is an estimate of the synchronous variance of the angular vibration signal s(θ) in relation to the cyclic period Φ, such that

$$( θ ) = \frac{1}{K} {{\sum }_{i =}^{K -} [ \hat{r} ( θ + i \cdot Φ ) ]}^{2} ;$$

\hat{r}(θ) is an estimate of a residual of the angular vibration signal s(θ) such that \hat{r}(θ)=s(θ)−\hat{m}(θ);
\hat{m}(θ) is the estimate of the synchronous mean in relation to the cyclic period Φ such that

$$\hat{m} ( θ ) = \frac{1}{K} {\sum }_{i =}^{K -} s ( θ + i \cdot Φ ) ;$$

\sqrt{ } is the square root function;
Σ is the sum function;
Φ is the cyclic period of the angular vibration signal s(θ);
K is a number of cycles such that

$$K = \frac{N}{Φ} ;$$

N is a number of sampling points forming the angular vibration signal s(θ); and
i is an integer varying from 0 to (K−1).

This case may correspond, for example, to the specific monitoring of gears, such as toothed wheels, pinions or ring gears, and rotating shafts.

Student's test can be used to test and verify the hypothesis of normality of the vibration phenomenon for each angle θ of the rotating member about the rotation axis AX.

The statistical indicator η_{α}(θ) is determined by taking, in Student's test, a risk 1−α that the angular vibration signal s(θ) is incorrectly considered to be non-cyclostationary when it is cyclostationary, or, conversely, this risk 1−α is associated with a confidence interval of width ±t_{α}^{K-1}, t_{α}^{K-1} being the quantile for Student's law with K−1 degrees of freedom.

Therefore, the method can be used to determine, for each angle θ, whether the vibration signal is cyclostationary or not, by comparing the estimate \hat{m}(θ) of the synchronous mean with the statistical indicator η_{α}(θ). If the estimate \hat{m}(θ) of the synchronous mean is greater than the statistical indicator η_{α}(θ), the vibration signal may be considered to be cyclostationary for this angle θ. Conversely, if the estimate \hat{m}(θ) of the synchronous mean is less than or equal to the statistical indicator η_{α}(θ), the vibration signal may be considered not to be cyclostationary for this angle θ.

The next step is to check whether the vibration signal is cyclostationary overall, i.e., over the range of variation of the angle θ in order to conclude whether there is a potential risk of presence of a fault in the mechanical system.

To this end, the calculation of the cyclostationarity indicator I_{α} relating to the estimate \hat{m} of the synchronous mean may then be determined by the ratio of the sum, over the range of variation of the angle θ, of the absolute values of the estimates \hat{m}(θ) of the synchronous mean satisfying the cyclostationarity criterion, i.e., greater than the statistical indicator η_{α}(θ), to the sum of the absolute values of all of the estimates \hat{m}(θ) of the synchronous mean over the range of variation of the angle θ.

The cyclostationarity indicator I_{α} can therefore be written according to the following relationship

$${I}_{α} = \frac{{\sum }_{θ} ( \vert \hat{m} ( θ ) \vert \cdot {𝒥}_{C y c} ( θ ) )}{{\sum }_{θ} \vert \hat{m} ( θ ) \vert} .$$

[symbol] _{Cyc}(θ) is an indicator function of the cyclostationarity of the angular vibration signal s(θ) that is equal to 1 if \hat{m}(θ)>η_{α}(θ) and equal to 0 if \hat{m}(θ)≤η_{α}(θ), and ∥ is the absolute value function.

This cyclostationarity indicator I_{α} is normalized and indicates a level of cyclostationarity of the vibration signal over the range of variation of the angle θ. This cyclostationarity indicator I_{α} may then be compared to the cyclostationarity threshold in order to determine whether or not the angular vibration signal s(θ) can be considered to be cyclostationary over the range of variation of the angle θ. The cyclostationarity threshold therefore corresponds to a minimum level of cyclostationarity for the angular vibration signal s(θ) to be considered to be cyclostationary, meaning that it comprises a significant number of cyclostationary components over the range of variation of the angle θ.

According to another example compatible with the preceding examples, the method is intended to determine cyclostationarity of order 2, the statistical hypothesis test is Bartlett's test applied to an estimate [symbol] of a synchronous variance of the angular vibration signal s(θ) in relation to a cyclic period Φ and the cyclostationarity indicator I_{α} is calculated according to the following relationship:

$${I}_{α} = exp ( - \frac{{x}_{α}^{2}}{ψ} ) ,$$

wherein exp is the exponential mathematical function;
   ψ is a scalar determined as a function of the estimate [symbol] of the synchronous variance of the angular vibration signal s(θ) such that:

$$ψ = \frac{3 N \cdot ( K - 1 ) \cdot [ ln ( {\sum }_{n = 1}^{N} ( {θ}_{n} ) / N ) - {\sum }_{n = 1}^{N} ln ( ( {θ}_{n} ) ) / N ]}{3 N \cdot ( K - 1 ) + N + 1} ;$$

[symbol] (θ) is the estimate of the synchronous variance in relation to the cyclic period Φ, such that

$$( θ ) = \frac{1}{K} {{\sum }_{i = 0}^{K - 1} [ \hat{r} ( θ + i \cdot Φ ) ]}^{2} ;$$

\hat{r}(θ) is an estimate of a residual of the angular vibration signal s(θ) such that \hat{r}(θ)=s(θ)−\hat{m}(θ);
\hat{m}(θ) is an estimate of the synchronous mean of the angular vibration signal s(θ) in relation to the cyclic period Φ, such that

$$\hat{m} ( θ ) = \frac{1}{K} {\sum }_{i = 0}^{K - 1} s ( θ + i \cdot Φ ) ;$$

Σ is the sum function;
θ is the angular position of the rotating member about the rotation axis AX;
Φ is the cyclic period of the angular vibration signal s(θ);
K is a number of cycles such that

$$K = \frac{N}{Φ} ;$$

N is a number of sampling points forming the angular vibration signal s(θ);
i is an integer varying from 0 to (K−1);
ln is the natural logarithm function; and
[symbol] _{α}² is a confidence interval associated with a chi-squared distribution with (N−1) degrees of freedom with a risk 1−α.

This case may correspond, for example, to the specific monitoring of bearings and, in particular, rolling bearings. The cyclostationarity indicator I_{α} is in this case calculated as a function of the synchronous variance of the angular vibration signal s(θ).

Bartlett's test makes it possible to compare the N variances resulting from the N normal distributions of the K samples of the K cycles of the angular vibration signal s(θ), by taking into account, overall, the synchronous variance of the angular vibration signal s(θ), unlike Fisher's exact test, that only compares the samples in pairs.

The scalar ψ is determined for the entire range of variation of the angle θ, in particular as a function of the estimate [symbol] of the synchronous variance of the angular vibration signal s(θ), and follows a chi-squared distribution [symbol] ² with N−1 degrees of freedom, making it possible to determine the confidence interval [symbol] _{α}² corresponding to the quantile for the chi-squared distribution and associated with a risk 1−α that the angular vibration signal s(θ) is incorrectly considered to be non-cyclostationary when it is cyclostationary, or vice versa.

The cyclostationarity indicator I_{α} is in this case determined directly over the entire range of variation of the angle θ, and may be compared to the cyclostationarity threshold in order to determine whether the vibration signal is cyclostationary overall.

The present disclosure also relates to an arrangement method for arranging at least one vibration sensor dedicated to monitoring a mechanical system, the mechanical system comprising at least one rotating member that rotates about a rotation axis AX, at least one vibration sensor, one angular sensor, and one calculator.

This arrangement method comprises the following steps carried out over at least two successive iterations:
positioning and orienting said at least one vibration sensor on the mechanical system, said at least one vibration sensor being situated in a different position and/or orientation at each iteration;
transmitting a temporal vibration signal x(t), by means of said at least one vibration sensor, for different operating modes of the mechanical system;
transmitting a temporal angular signal θ(t), by means of the angular sensor, that varies as a function of an angular position of the rotating member about the rotation axis AX for the different operating modes of the mechanical system; and
calculating a cyclostationarity indicator I_{α} relative to the temporal vibration signal x(t) for the different operating modes of the mechanical system, by applying the method for determining cyclostationarity described above.

This arrangement method also comprises a step of validating the position and orientation of said at least one vibration sensor on the mechanical system, wherein the position and the orientation of said at least one vibration sensor are validated if a characteristic value of the cyclostationarity indicators relating to the position and the orientation of said at least one vibration sensor for the different operating modes of the mechanical system is greater than a validation threshold, the characteristic value being chosen from a median value of the cyclostationarity indicators, an arithmetic mean of the cyclostationarity indicators or a root mean square of the cyclostationarity indicators.

The step of positioning said at least one vibration sensor on the mechanical system, the two steps of transmitting signals and the step of calculating the cyclostationarity indicator I_{α} are repeated at least twice, and possibly many times, in order to test several positions and several orientations of said at least one sensor on the mechanical system and determine the cyclostationarity indicators I_{α} relating respectively to various arrangements each defining a position and an orientation.

Between two iterations, the vibration sensor or sensors are moved by changing their position and/or orientation, for example on a rotating member, a bearing, a toothed ring gear or a toothed wheel.

Therefore, a set of values of cyclostationarity indicators I_{α} relating respectively to different operating modes of the mechanical system may be associated with each arrangement comprising a position and an orientation of a vibration sensor. “Operating mode of the mechanical system” should be understood to mean the operation of the mechanical system with a specific speed of rotation of a member or a specific torque on the rotating member or specific forces applied to the rotating member. Two different operating modes may produce the same speed of rotation of the rotating member but different torques. Similarly, two different operating modes may produce different speeds of rotation of the rotating member but identical torques. However, two different operating modes cannot produce the same speed of rotation of the rotating member and the same torque.

Next, these cyclostationarity indicators I_{α} are compared to a validation threshold in order to identify and validate the position and the orientation of said at least one vibration sensor on the mechanical system allowing reliable and usable measurements to be obtained, thus ensuring effective vibration monitoring of the mechanical system.

In particular, the characteristic values of the cyclostationarity indicators I_{α} relating to various arrangements each defining a position and an orientation of said at least one vibration sensor for the different operating modes of the mechanical system are compared to this validation threshold. The characteristic value may be chosen from a median value of the cyclostationarity indicators I_{α}, i.e., a value for which the number of cyclostationarity indicators I_{α} that are greater than this median value is equal to the number of cyclostationarity indicators I_{α} that are less than this median value, an arithmetic mean of the cyclostationarity indicators I_{α} or a root mean square of the cyclostationarity indicators I_{α}, for example.

Each arrangement of the vibration sensor for which the characteristic value of the cyclostationarity indicators I_{α} is greater that the validation threshold is therefore validated, several arrangements therefore being able to be validated. The validation threshold is, for example, equal to 0.6.

The position and the orientation of the vibration sensor relating to each validated arrangement may, for example, be stored in a memory in order to be able to be used when manufacturing such mechanical systems, in order to position and set the orientation of each vibration sensor.

The normalization of the cyclostationarity indicator I_{α} advantageously makes it possible to effectively and reliably compare the values of the cyclostationarity indicator I_{α} irrespective of the positions and/or the orientations of the vibration sensors, even though the vibration signals supplied by these vibration sensors may be significantly different.

This arrangement method is therefore a valuable aid in finding the optimum position and orientation of a vibration sensor dedicated to monitoring a mechanical system during the development and testing of this mechanical system. This arrangement method therefore makes it possible to ensure that the temporal vibration signal acquired by this vibration sensor during the final operation of the mechanical system is reliable and valid for robust vibration monitoring of the mechanical system.

The method according to the disclosure may comprise one or more of the following features, taken individually or in combination.

According to one example, during the validation step, the position and orientation of said at least one vibration sensor may be validated if a difference between a maximum value and a minimum value of the cyclostationarity indicators I_{α} relating to this position and this orientation is also less than a difference threshold. The difference threshold may, for example, be equal to a percentage of the characteristic value of the cyclostationarity indicators I_{α}. This percentage is, for example, equal to 25%. This validation criterion therefore makes it possible to exclude a position or an orientation of a vibration sensor that would give very different measurements from one operating mode to another, that would therefore be unreliable and of little use.

Irrespective of the validation criterion or criteria used, several arrangements combining a position or an orientation of a vibration sensor may be validated. If several arrangements are validated, the position and orientation of the vibration sensor may be chosen according to the arrangement with the greatest margin in relation to one of these thresholds. Additionally, or alternatively, if several arrangements are validated, the position and orientation of the vibration sensor may be chosen according to the ease of installing the sensor, for example in terms of accessibility and/or the low risk of it being impacted by other members of the mechanical system. For example, the chosen arrangement may be that for which the characteristic value of the cyclostationarity indicators I_{α} is the highest, in this case closest to 1. Alternatively, or additionally, the chosen arrangement may be that for which the difference between the maximum value and the minimum value of the cyclostationarity indicators I_{α} is the lowest.

Moreover, and irrespective of the criterion or criteria used to validate the position and the orientation of the vibration sensor used, the different operating modes of the mechanical system may only comprise stabilized operating modes. Therefore, transient operating modes are excluded from the measurements taken by said at least one vibration sensor for each of its positions and orientations.

Alternatively, or additionally, a filter may be applied to the values of the cyclostationarity indicators I_{α} in order to remove extreme values and/or outliers likely to correspond to transient operating modes or to particular operating modes.

According to another example compatible with the preceding examples, the method according to the disclosure may comprise a step of arranging at least one vibration sensor on the mechanical system according to a validated arrangement defining a position and an orientation. The mechanical system is therefore equipped with one or more vibration sensors whose position and orientation have been tested and validated in order to allow reliable and effective monitoring of the mechanical system by means of one or more monitoring indicators determined as a function of temporal vibration signals transmitted by this or these vibration sensors.

The present disclosure also relates to a method for monitoring a mechanical system, the mechanical system comprising at least one rotating member that rotates about a rotation axis AX, at least one vibration sensor transmitting a temporal vibration signal s(t), an angular sensor transmitting a temporal angular signal θ(t) that varies as a function of an angular position of the rotating member about the rotation axis AX, and a calculator.

The method includes the following steps:
transmitting the temporal vibration signal s(t) by means of said at least one vibration sensor;
transmitting the temporal angular signal θ(t) by means of the angular sensor;
calculating a cyclostationarity indicator I_{α} for the temporal vibration signal s(t), by applying the method for determining cyclostationarity described above;
if the cyclostationarity indicator I_{α} is greater than or equal to the cyclostationarity threshold, calculating at least one monitoring indicator of the mechanical system, with the calculator, as a function of the temporal vibration signal s(t); and
determining the presence of a fault in the mechanical system by comparing said at least one monitoring indicator with a fault threshold.

Therefore, after measuring and transmitting the temporal vibration signal s(t) by means of said at least one vibration sensor and measuring and transmitting the temporal vibration signal θ(t) by means of the angular sensor, the steps of the method for determining the cyclostationarity of the temporal vibration signal s(t) are carried out in order to verify the cyclostationarity of this temporal vibration signal s(t).

In this way, the temporal vibration signal s(t) is analysed and the cyclostationarity indicator I_{α} relating to this temporal vibration s(t) signal is calculated, and the cyclostationarity or the non-cyclostationarity of this temporal vibration signal s(t) is then determined.

If the cyclostationarity of the temporal vibration signal s(t) is confirmed, i.e., if the cyclostationarity indicator I_{α} is greater than or equal to the cyclostationarity threshold, the temporal vibration signal s(t) is likely to comprise signs that a fault has occurred in the mechanical system. As a result, at least one monitoring indicator may then be determined as a function of this temporal vibration signal s(t) in order to be used with confidence for monitoring the mechanical system.

Conversely, if the non-cyclostationarity of the temporal vibration signal s(t) is confirmed, i.e., if the cyclostationarity indicator I_{α} is less than the cyclostationarity threshold, no monitoring indicator of the mechanical system is calculated as a function of this temporal vibration signal s(t), the temporal vibration signal s(t) not comprising any sign that a fault has occurred in the mechanical system.

This method therefore advantageously makes it possible to determine a robust monitoring indicator capable of effectively and reliably detecting faults in the mechanical system, after first excluding the vibration signals that are probably stationary and therefore not representative of the potential presence of faults.

A fault may effectively be present in the mechanical system, for example, if a monitoring indicator is greater than the fault threshold.

Such a monitoring indicator may, for example, be calculated as a function of the temporal vibration signal s(t) or the angular vibration signal s(θ). Such a monitoring indicator may also be calculated as a function of the cyclostationarity indicator I_{α}, or be equal to the cyclostationarity indicator I_{α}.

The present disclosure also relates to a computer program comprising instructions that, when the program is run, cause it to implement one of the methods described above. The computer program may, for example, be run by a calculator. The instructions are, for example, stored in a memory of the calculator or connected to the calculator.

The present disclosure also relates to a device for determining cyclostationarity for validating whether a temporal vibration signal x(t) to a relating mechanical system is cyclostationary. Such a validation device is intended and configured for a mechanical system comprising at least one rotating member that rotates about a rotation axis AX and at least one vibration sensor transmitting the temporal vibration signal x(t). The device for determining cyclostationarity comprises an angular sensor transmitting a temporal angular signal θ(t) that varies as a function of an angular position of the rotating member about the rotation axis AX, and a calculator.

This device for determining cyclostationarity is configured to implement the method for determining cyclostationarity as described above.

The present disclosure also relates to a device for arranging at least one vibration sensor dedicated to monitoring a mechanical system, the mechanical system comprising at least one rotating member that rotates about a rotation axis AX, and at least one vibration sensor. The arrangement device comprises an angular sensor transmitting a temporal angular signal θ(t) that varies as a function of an angular position of the rotating member about a rotation axis AX, and a calculator,

This arrangement device is configured to implement the arrangement method described above. The arrangement device is configured in particular to implement, over at least two successive iterations, after having previously positioned and oriented said at least one vibration sensor on the mechanical system, the steps of transmitting a temporal vibration signal x(t), by means of said at least one vibration sensor, for different operating modes of the mechanical system, of transmitting a temporal angular signal θ(t), by means of the angular sensor, and of calculating a cyclostationarity indicator I_{α} of the arrangement method. Said at least one vibration sensor is located at a different position and/or orientation at each iteration. Next, the arrangement device may implement the step of validating the position and orientation of said at least one vibration sensor on the mechanical system, wherein the position and the orientation of said at least one vibration sensor are validated if a characteristic value of the cyclostationarity indicators relating to the position and the orientation of said at least one vibration sensor for the different operating modes of the mechanical system is greater than a validation threshold.

The present disclosure also relates to a monitoring device for monitoring a mechanical system, the monitoring device being configured to monitor a mechanical system comprising at least one rotating member that rotates about a rotation axis AX. The monitoring device comprises at least one vibration sensor measuring the temporal vibration signal s(t), an angular sensor measuring a temporal angular position θ(t) of the rotating member about a rotation axis AX, and a calculator. This monitoring device is configured to implement the method for monitoring a mechanical system as described above and thus detect the presence of a fault in a mechanical system.

The present disclosure also relates to a mechanical system comprising at least one rotating member that rotates about a rotation axis AX and a monitoring device as described above for monitoring the mechanical system and detecting the presence of a fault in the mechanical system.

This mechanical system may, for example, be a gearbox of a vehicle, and in particular of an aircraft.

The present disclosure also relates to a gearbox comprising a mechanical system as described above.

The gearbox may, for example, be fitted in a vehicle and be inserted between at least one heat engine or electric motor and at least one rotor of an aircraft.

The present disclosure may finally relate to a vehicle comprising a mechanical system and/or a gearbox, in particular an aircraft.

### BRIEF DESCRIPTION OF THE DRAWINGS

The disclosure and its advantages appear in greater detail in the context of the following description of embodiments given by way of illustration and with reference to the accompanying figures, wherein:

FIG. 1 is a schematic side view of an aircraft;

FIG. 2 is a diagram showing a method for determining the cyclostationarity of a temporal vibration signal relating to a mechanical system;

FIG. 3 is a diagram showing a method for arranging at least one vibration sensor dedicated to monitoring a mechanical system;

FIG. 4 is a diagram showing the process of vibration analysis of a mechanical system including the disclosure; and

FIG. 5 is a diagram showing a method for monitoring a mechanical system.

### DETAILED DESCRIPTION

Elements that are present in more than one of the figures are given the same references in each of them.

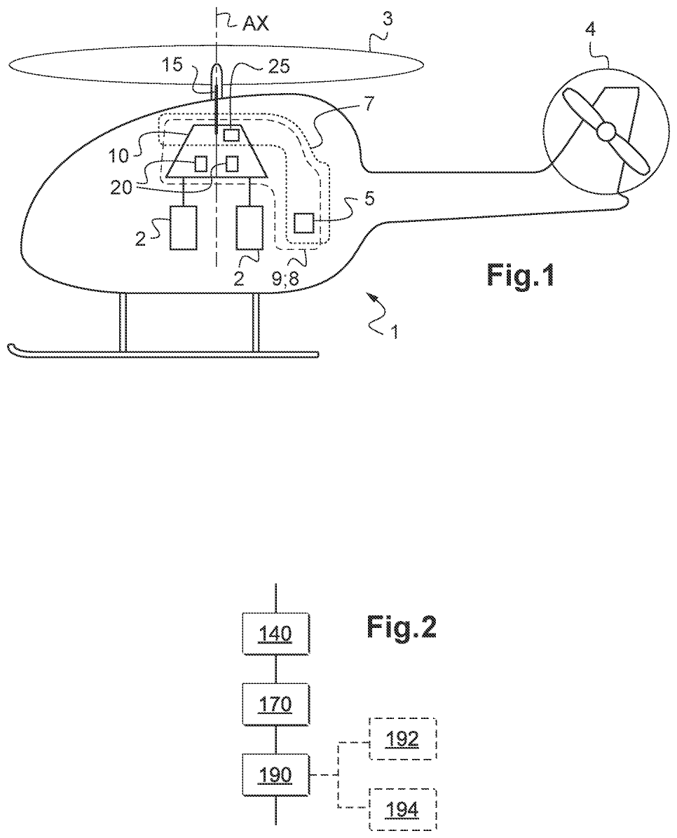

FIG. 1 shows a vehicle 1, and in particular a rotary-wing aircraft such as a rotorcraft. This vehicle 1 comprises a mechanical system 10 provided with one or more rotating members 15 that rotate about a rotation axis AX. A rotating member 15 may, for example, comprise an output shaft or an input shaft.

Such a mechanical system 10 may comprise one or more rotational guide bearings, for example, for guiding at least one rotating member in rotation. A bearing comprises a rolling bearing provided with rolling elements, for example.

Such a mechanical system 10 may also comprise, for example, at least a toothed wheel, pinion or toothed ring gear, which may be fixed or mobile.

This mechanical system 10 may, for example, be a transmission or a gearbox of the rotary wing aircraft 1. This mechanical system 10 may be connected, for example, to one or more engines 2, via one or more input shafts respectively, and may rotate a rotor, such as, for example, a main rotor 3 via an output shaft, or possibly an auxiliary rotor 4, as shown in FIG. 1.

Alternatively, such a mechanical system 10 may be arranged in a transmission or gearbox of a vehicle 1 or any other piece of mechanical equipment.

Irrespective of its arrangement, the mechanical system 10 also comprises one or more vibration sensors 20, an angular sensor 25 measuring an angular position of a rotating member 15 about a rotation axis AX, and a calculator 5. The mechanical system 10 may comprise several angular sensors 25 arranged respectively on several different rotating members 15.

Each vibration sensor 20 can measure and/or transmit a temporal vibration signal s(t) relating to vibrational behavior of the mechanical system 10 as a whole, or to particular vibrational behavior of a rotating member 15, a bearing or a gear, for example. A vibration sensor 20 can transmit a temporal vibration signal s(t) in electrical, optical, analog or digital form. The temporal vibration signal carries s(t) information relating to the vibrational behavior of the mechanical system 10 or one of its components. The temporal vibration signal s(t) may be transmitted, via a wired or wireless link, to the calculator 5. The vibration sensor or sensors 20 may, for example, comprise an accelerometer, a tachometer, an encoder-type sensor and/or a strain gauge.

The angular sensor 25 measures an angular position of a rotating member 15 about a rotation axis AX. The angular position of the rotating member 15 about the rotation axis AX may be defined in relation to a reference frame of the mechanical system 10, for example a casing of the mechanical system 10. The angular sensor 25 may transmit the temporal angular signal θ(t) in electrical, optical, analog or digital form. The temporal angular signal θ(t) may carry information relating to the angular position of the rotating member 15 about the rotation axis AX and may be transmitted, via a wired or wireless link, to the calculator 5.

The angular sensor 25 may comprise an angular position sensor directly measuring a temporal angular signal indicating the variation of the angular position of the rotating member 15 as a function of time.

Alternatively, the angular sensor 25 may comprise an angular speed sensor or an angular acceleration sensor measuring a temporal angular signal relating respectively to an angular speed or to an angular acceleration which must undergo single integration or double integration, in order to generate a temporal angular signal supplying the variation in the angular position of the rotating member 15 as a function of time. This single or double integration may be carried out by the calculator 5, the angular sensor 25 transmitting the measured temporal angular signal to the calculator 5 in the form of an electrical, optical, analog or digital signal, via a wired or wireless link. This single or double integration may also be carried out by a calculator integrated into the angular sensor 25.

The temporal vibration signal s(t) and the temporal angular signal θ(t) may, for example, be measured continuously during the operation of the mechanical system 10.

The temporal vibration signal s(t) and the temporal angular signal θ(t) may also be measured over fixed or variable measurement time periods during the operation of the mechanical system 10. The measurement time periods may, for example, be between several dozen seconds and a few minutes.

The calculator 5 may comprise at least one processor and at least one memory, at least one integrated circuit, at least one programmable system or indeed at least one logic circuit, these examples not limiting the scope given to the expression “calculator”. The calculator 5 may also be connected to a memory by a wired or wireless link.

The memory may, for example, store instructions or algorithms relating to the implementation of the methods and one or more thresholds corresponding to these methods. The memory may also store computer programs intended to be run by the calculator 5 in order to implement the methods.

The vibration sensor or sensors 20 and the angular sensor 25 and the calculator 5 may be part of a monitoring device 9 for monitoring the mechanical system 10 intended to monitor the mechanical system in order to detect and identify a risk of occurrence or presence of a fault likely to result in a failure or malfunction of the mechanical system 10.

The angular sensor 25 and the calculator 5 may be part of a device for determining the cyclostationarity 7 of a temporal vibration signal relating to the mechanical system 10, this temporal vibration signal being transmitted by one of the vibration sensors 20 of the mechanical system 10.

The vibration sensor or sensors 20 and the angular sensor 25 and the calculator 5 may be part of a device 8 for arranging at least one vibration sensor 20 dedicated to monitoring the mechanical system 10.

The calculator 5 may be a single calculator shared between the different devices 7,8,9. Alternatively, each device 7,8,9 may comprise a specific dedicated calculator 5.

The device for determining cyclostationarity 7 is configured to implement a method for determining the cyclostationarity of a temporal vibration signal s(t) relating to the vibrations of the mechanical system 10, the different steps of which are shown in FIG. 2.

Indeed, it may be beneficial to know whether a temporal vibration signal s(t) is non-cyclostationary or cyclostationary. The presence of cyclostationary components may be a sign of the possible presence of a fault in the mechanical system 10, and in particular in a rotating member 15, a gear or a bearing.

This method for determining the cyclostationarity of a temporal vibration signal s(t) relating to the vibrations of the mechanical system 10 comprises the following steps.

Firstly, during a transformation step 140, the temporal vibration signal s(t) transmitted by said at least one vibration sensor 20 is transformed in a known manner into an angular vibration signal s(θ), by the calculator 5, as a function of the temporal angular signal θ(t) transmitted by the angular sensor 25.

This transformation 140 therefore makes it possible to resample the temporal vibration signal s(t) from the time domain to the angular domain. Such a transformation of a temporal vibration signal s(t) into the angular domain may in particular make it possible to extract periodic statistical properties when such a signal displays speed fluctuations.

Such a transformation of the temporal vibration signal s(t) into an angular vibration signal s(θ) may, for example, be written as follows:

$$s ( θ ) = ℛ \{ s ( t ) \} ,$$

[symbol]

being the operation of resampling the time domain to the angular domain as a function of the temporal angular signal θ(t) relating to the angular position of the rotating member 15.

Following this transformation and during a calculation step 150, a normalized cyclostationarity indicator I_{α} is determined by the calculator 5 using a statistical hypothesis test and as a function of the angular signal vibration s(θ). This cyclostationarity indicator I_{α} is normalized and therefore between 0 and 1.

A cyclostationarity indicator I_{α} equal to 0 or close to 0 means that the angular vibration signal s(θ) does not comprise a cyclostationarity component of order 1 or 2. Conversely, the cyclostationarity indicator is equal to 1 or close to 1 when the angular vibration signal s(θ) comprises, with a high level of confidence, a cyclostationarity component of order 1 or of order 2.

This cyclostationarity indicator I_{α} may, for example, be determined as a function of a synchronous mean or a synchronous variance of the angular vibration signal s(θ).

In particular, when the method according to the disclosure is used to determine cyclostationarity of order 1, the statistical hypothesis test may be Student's test applied to an estimate \hat{m}(θ) of a synchronous mean of the angular vibration signal s(θ) in relation to a cyclic period ¢.

A cyclostationarity indicator I_{α} based on an estimate \hat{m}(θ) of the synchronous mean of the angular vibration signal s(θ) in relation to the cyclic period Φ is particularly suited to the vibration analysis of gears and rotating shafts of the mechanical system 10. Indeed, for these elements of the mechanical system 10, the statistical moment of order 1 of the cyclostationary signals of order 1 is periodic in time.

The estimate \hat{m}(θ) of the synchronous mean in relation to the cyclic period Φ may be defined according to the following relationship:

$$\hat{m} ( θ ) = \frac{1}{K} {\sum }_{i = 0}^{K - I} s ( θ + i \cdot Φ ) ,$$

wherein t_{α}^{K-1} is half of the confidence interval associated with Student's Iaw with K−1 degrees of freedom applied with a risk 1−α;
   θ is the angular position of said rotating member (15) about said rotation axis (AX);
   Σ is the sum function;
Φ is the cyclic period of the angular vibration signal s(θ);
K is a number of cycles such that

$$K = \frac{N}{Φ} ;$$

N is a number of sampling points forming the angular vibration signal s(θ); and
i is an integer varying from 0 to (K−1).
   The angular vibration signal s(θ) can thus be written as follows: s(θ)=m(θ)+cs(θ)+b(θ), where m(θ) is the synchronous mean of the angular vibration signal s(θ), cs(θ) is the cyclostationary component of order greater than 1, and b(θ) is the centered Gaussian stationary noise that is independent of the synchronous mean m(θ) and the cyclostationary component cs(θ).

The angular vibration signal s(θ) is defined as being stationary, and therefore non-cyclostationary, when its statistical moments are invariant as a function of the angle θ. There is then a cyclostationary component cs(θ) of order greater than 1 that is zero and a synchronous mean m(θ) that is constant and, for example, equal to a value C.

Therefore, when the angular vibration signal s(θ) is stationary, the estimate m(θ) of the synchronous mean tends towards this constant value C when the number of cycles K increases. The estimate \hat{m}(θ) of the synchronous mean is therefore independent of the angle θ. The estimate \hat{m}(θ) generally follows a normal distribution, the variance of which is inversely proportional to the number of cycles K.

However, when the angular vibration signal s(θ) is cyclostationary of order 1, and therefore non-stationary, the estimate \hat{m}(θ) of the synchronous mean tends towards the synchronous mean m(θ) and therefore depends on the angle θ.

Student's hypothesis test can be used to test the hypothesis of normality of the angular vibration signal s(θ) for each angle θ when the angular vibration signal s(θ) is stationary. Student's hypothesis test is carried out N times to compare the estimate \hat{m}(θ) of the synchronous mean for given respective angles θ relative to a theoretical zero mean.

A variable ρ(θ) may be defined according to the following relationship

$$ρ ( θ ) = \frac{\hat{m} ( θ )}{\hat{σ} ( θ ) {/}_{\sqrt{K}}}$$

wherein \hat{σ}(θ) is an estimate of the standard deviation of the angular vibration signal s(θ) satisfying a normal distribution for an angle θ defined such that

$$\hat{σ} ( θ ) = \sqrt{( θ ) \cdot \frac{K}{K - 1}} .$$

The variable ρ(θ) follows Student's law if and only if the angular vibration signal s(θ) is stationary. This variable ρ(θ) is in this case less than or equal to a quantile t_{α}^{K-1} associated with Student's law with K−1 degrees of freedom and corresponding to a risk 1−α that the variable ρ(θ) follows a normal distribution.

Conversely, if the angular vibration signal s(θ) is cyclostationary of order 1, then this variable ρ(θ) is greater that the quantile t_{α}^{K-1}. Student's test then gives a negative result.

As a result, it is possible to define a statistical indicator η_{α}(θ) that can be used to check with a risk 1−α whether the angular vibration signal s(θ) is non-cyclostationary or cyclostationary of order 1.

To this end, the calculation 170 of a cyclostationarity indicator η_{α} comprises an intermediate step of determining a statistical indicator η_{α}(θ) calculated by the calculator 5. The statistical indicator η_{α}(θ) may be calculated by applying the following relationship:

$${η}_{α} ( θ ) = {t}_{α}^{K - 1} \cdot \frac{\hat{σ} ( θ )}{\sqrt{K}} ,$$

wherein t_{α}^{K-1} is half of the confidence interval associated with Student's law with K−1 degrees of freedom applied with a risk 1−α that the angular vibration signal s(θ) is non-cyclostationary or cyclostationary of order 1;
   [symbol] (θ) is an estimate of said synchronous variance of the angular vibration signal s(θ) in relation to the cyclic period Φ, such that

$$( θ ) = \frac{1}{K} {{\sum }_{i = 0}^{K - 1} [ \hat{r} ( θ + i \cdot Φ ) ]}^{2} ;$$

\hat{r}(θ) is an estimate of a residual of the angular vibration signal s(θ) such that \hat{r}(θ)=s(θ)−\hat{m}(θ); and
\sqrt{V} is the square root function.

The risk 1−α associated with this statistical indicator η_{α}(θ) corresponds to the probability that, for an angle θ, the estimate \hat{m}(θ) of the synchronous mean of the angular vibration signal s(θ) is greater than the corresponding statistical indicator η_{α}(θ), whereas the angular vibration signal s(θ) for this angle θ is in fact not cyclostationary, or conversely that this estimate \hat{m}(θ) of the synchronous mean is less than or equal to the corresponding statistical indicator η_{α}(θ) for this angle θ, whereas the angular vibration signal s(θ) for this angle θ is in fact cyclostationary.

The risk 1−α is, for example, 5%.

In the event that the angular vibration signal s(θ) is cyclostationary over the range of variation of the angle θ, a significant number of the values of the estimate \hat{m}(θ) of the synchronous mean is greater than the statistical indicator η_{α}(θ). The cyclostationarity indicator I_{α} therefore tends towards 1 when this number of values of the estimate \hat{m}(θ) of the synchronous mean greater than the statistical indicator η_{α}(θ) increases, thus confirming the cyclostationarity of the angular vibration signal s(θ).

The cyclostationarity indicator I_{α} is, for example, equal to a ratio of the sum of the absolute values of the estimates \hat{m}(θ) of the synchronous mean that are greater than the statistical indicator η_{α}(θ), over the range of variation of the angle θ, to the sum of the absolute values of all of the estimates \hat{m}(θ) of the synchronous mean over this range of variation of the angle θ.

The calculator 5 can apply the relationship

$${I}_{α} = \frac{{\sum }_{θ} ( \vert \hat{m} ( θ ) \vert . {𝒥}_{Cyc} ( θ ) )}{{\sum }_{θ} \vert \hat{m} ( θ ) \vert}$$

to calculate the cyclostationarity indicator I_{α},
wherein [symbol] _{Cyc}(θ) is an indicator function of the cyclostationarity of the angular vibration signal that is equal to 1 if \hat{m}(θ)>η_{α}(θ) and to 0 if \hat{m}(θ)≤η_{α}(θ); and
   ∥ is the absolute value function.

When the method according to the disclosure is used to determine cyclostationarity of order 2, the statistical hypothesis test may be Bartlett's test applied to an estimate [symbol] (θ) of a synchronous variance of the angular vibration signal s(θ) in relation to the cyclic period Φ.

A cyclostationarity indicator I_{α} based on an estimate \hat{m}(θ) of the synchronous variance of the angular vibration signal s(θ) is particularly suited to the vibration analysis of the rolling bearings of the mechanical system 10. Indeed, for rolling bearings, the statistical moment of order 1 of the cyclostationary signals of order 1 is periodic in time.

Bartlett's test is used to compare the N variances resulting from N normal distributions of the K samples of the K cycles of the angular vibration signal s(θ), by taking into account, overall, the synchronous variance vs(θ) of the angular vibration signal s(θ).

An estimate [symbol] (θ) of the synchronous variance of the angular vibration signal s(θ) in relation to the cyclic period Φ is defined according to the following relationship:

$$( θ ) = \frac{1}{K} {{\sum }_{i = 0}^{i = K - 1} [ \hat{r} ( θ + i . Φ ) ]}^{2} .$$

In this case, a scalar ψ may be determined as a function of the estimate [symbol] (θ) of the synchronous variance according to the following relationship:

$$ψ = \frac{3 N . ( K - 1 ) . [ ln ( {\sum }_{n = 1}^{N} ( {θ}_{n} ) / N ) - {\sum }_{n = 1}^{N} ln ( ( {θ}_{n} ) ) / N ]}{3 N . ( K - 1 ) + N + 1} ,$$

where ln is the natural logarithm function. This scalar ψ is calculated over the entire range of variation of the angle θ.

This scalar ψ follows a chi-squared distribution [symbol] ² with N−1 degrees of freedom. A confidence interval [symbol] _{α}² relative to this chi-squared distribution and associated with a risk 1−α may be determined.

When the angular vibration signal s(θ) is stationary, the statistical moments are time-invariant. The scalar ψ is then less than or equal to the confidence interval [symbol] _{α}².

Conversely, if the angular vibration signal s(θ) is cyclostationary of order 1, this scalar y is then greater than to the confidence interval [symbol] _{α}². Bartlett's test then gives a negative result.

The cyclostationarity indicator I_{α} may then be calculated by the calculator 5 by applying the following relationship:

$${I}_{α} = exp ( - \frac{{x}_{α}^{2}}{ψ} ) ,$$

wherein exp is the exponential mathematical function.

In this way, a cyclostationarity indicator I_{α} can be calculated in relation to a cyclostationarity of order 1 or of order 2.

Finally, during a determination step 190, the angular vibration signal s(θ) is considered to be cyclostationary of order 1 or of order 2 when the cyclostationarity indicator I_{α} is greater than or equal to a predetermined cyclostationarity threshold. This predetermined cyclostationarity threshold is between 0 and 1.

Furthermore, the method according to the disclosure may comprise additional steps. For example, a step of generating 192 a cyclostationarity alert may be carried out when the cyclostationarity indicator I_{α} is greater than or equal to the cyclostationarity threshold in order to indicate to an operator or a pilot of the aircraft 1 that the vibration signal is cyclostationary.

Additionally, or alternatively, a step of generating 194 a non-cyclostationarity alert may be carried out when the cyclostationarity indicator I_{α} is less than the cyclostationarity threshold in order to indicate to an operator or a pilot of the aircraft 1 that the vibration signal is non-cyclostationary.

Each of these alerts may be visual alerts, for example being issued by illuminating one or more indicator lights, or displaying explicit messages or symbols on a screen. These alerts may also be audio alerts, for example being issued in the form of specific sounds or explicit messages. In both cases, the calculator 5 then transmits an electrical, optical, analog or digital alert signal carrying information relating to the alert to be generated, to an alerter that then emits the alert.

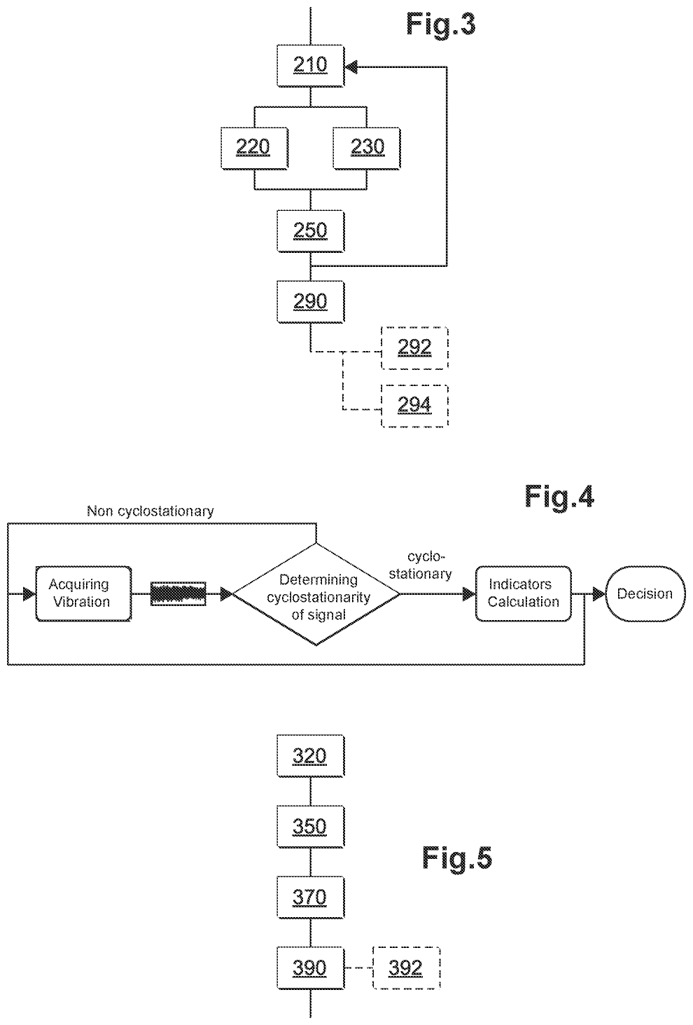

Moreover, the arrangement device 8 is configured to implement, in particular using the calculator 5, a method for arranging at least one vibration sensor 20 dedicated to monitoring the mechanical system 10, the different steps of which are shown in FIG. 3.

Firstly, during a positioning and orientation step 210, one or more vibration sensors 20 are positioned and oriented on the mechanical system 10. Each vibration sensor 20 is positioned in a position that is deemed relevant, for example close to or on a rotating member 15, a bearing, a toothed ring gear or a toothed wheel, with a specific orientation. This orientation of a vibration sensor 20 makes it possible to set one or more preferred directions of measurement of the vibration sensor 20 in relation to a reference frame of the mechanical system 10, for example in relation to a fixed frame or casing of the mechanical system 10, this reference frame comprising axes that are fixed in relation to this frame or casing.

Next, during a transmission step 220, temporal vibration signals s(t) relating to the vibrational behavior of the mechanical system 10 or one of its components are transmitted by said at least one vibration sensor 20 to the calculator 5. These temporal vibration signals s(t) are measured respectively during different operating modes of the mechanical system 10.

During a transmission step 230, temporal angular signals θ(t) that vary as a function of an angular position of the rotating member 15 about the rotation axis AX are transmitted by the angular sensor 25 to the calculator 5. These temporal angular signals θ(t) are measured respectively during different operating modes of the mechanical system 10.

The transmission steps 220 and 230 are carried out in parallel, or simultaneously and synchronously.

During a calculation step 250, a cyclostationarity indicator I_{α} relative to the temporal vibration signal s(t) is calculated for the different operating modes of the mechanical system 10, by applying the method for determining cyclostationarity described above. The steps of the method for determining the cyclostationarity 140, 170 and 190 are therefore carried out in order to transform and analyze the temporal vibration signal s(t), then calculate the cyclostationarity indicators I_{α} relating respectively to the different operating modes of the mechanical system 10.

These cyclostationarity indicators I_{α} may be calculated in order to determine a cyclostationarity of order 1 or of order 2.

The steps 210, 220, 230 and 250 are carried out over at least two iterations, or over more than two iterations.

At each iteration, the vibration sensor or sensors 20 are situated in different positions and/or orientations on the mechanical system 10. For example, between two iterations, a vibration sensor 20 may be moved by changing the position and/or the orientation of this vibration sensor 20.

The steps 220, 230 and 250 are thus carried out for each successive position and orientation of the vibration sensor or sensors 20 in relation to the mechanical system 10 chosen during the positioning and orientation step 110. A cyclostationarity indicator I_{α} may therefore be calculated for each arrangement of each vibration sensor 20, this arrangement defining a position of the vibration sensor 20 and its orientation, and for each operating mode of the mechanical system 10.

Next, during a validation step 280, the position and the orientation of said at least one vibration sensor 20 on the mechanical system 10 are validated as a function of a characteristic value of the cyclostationarity indicators I_{α} relating to each arrangement tested for the different operating modes of the mechanical system 10. An arrangement, and therefore a position and an orientation of said at least one vibration sensor 20, are thus validated if the characteristic value of the cyclostationarity indicators I_{α} relating to this position and this orientation for the different operating modes of the mechanical system 10 is greater than a validation threshold.

The validation threshold is between 0 and 1 and may be determined by tests or by simulations.

Each characteristic value relating to an arrangement of said at least one vibration sensor 20 is calculated as a function of the cyclostationarity indicators I_{α} relating to the position and the orientation according to this arrangement for the different operating modes of the mechanical system 10. A characteristic value may, for example, be equal to a median value of these cyclostationarity indicators I_{α}, to an arithmetic mean of these cyclostationarity indicators I_{α} or to a root mean square of these cyclostationarity indicators I_{α}.

In this way, one or more arrangements of said at least one vibration sensor 20 on the mechanical system 10 can be validated.

When several arrangements are validated, the arrangement of a vibration sensor for which the characteristic value of the cyclostationarity indicators I_{α} is the highest may be chosen, for example.

Other criteria may also be taken into account in order to validate the position and the orientation of a vibration sensor 20.

For example, during the validation step 280, the position and the orientation of a vibration sensor 20 may be validated if a maximum value and a minimum value of the cyclostationarity indicators I_{α} relating to this arrangement are separated by a difference smaller than a difference threshold. The difference threshold may be determined by tests or by simulations. This additional criterion therefore makes it possible to validate a position and an orientation for which the characteristic value of the cyclostationarity indicators I_{α} is greater that the validation threshold, and the values of these cyclostationarity indicators I_{α} have a limited dispersion.

Another validation criterion may be the slope of an average straight line constructed with the values of the cyclostationarity indicators I_{α} for each arrangement of the vibration sensor. Such an arrangement may, for example, be validated when the slope of such a straight line is less than a slope threshold. The slope threshold may be determined by tests or by simulations.

Moreover, the different operating modes of the mechanical system 10 used for measuring and transmitting temporal vibration signals s(t) and temporal angular signals θ(t) may comprise only stabilized operating modes, the transient operating modes thus being excluded.

Regardless of which validation criterion or criteria are used to validate the arrangement of each vibration sensor 20, the normalization of the cyclostationarity indicator I_{α} of the temporal vibration signal s(θ) advantageously makes it possible to reliably compare the values of this cyclostationarity indicator I_{α} irrespective of the positions and/or the orientations of this vibration sensor 20, even though the vibration signal supplied by this vibration sensor 20 may be significantly different according to these different arrangements.

Moreover, this method may also comprise a step 290 of arranging one or more vibration sensors 20 according to the validated positions and orientations.

FIG. 4 is a diagram showing a method for monitoring a mechanical system 10 using the method for determining the cyclostationarity of the vibration signal described above. This method for determining cyclostationarity is therefore used between the vibration measurements taken by one or more vibration sensors 20 and a method for monitoring a mechanical system 10, in order to monitor the mechanical system 10 reliably and effectively by means of the temporal vibration signal s(t) transmitted by each of these vibration sensors 20.

Furthermore, the device 9 for monitoring a mechanical system 10 is configured for the implementation, in particular using the calculator 5, of such a method for monitoring a mechanical system 10, the different steps of which are shown in FIG. 5.

Firstly, during a transmission step 320, at least one temporal vibration signal s(t) is transmitted to the calculator 5 by at least one vibration sensor 20.

During a transmission step 330, a temporal angular signal θ(t) is transmitted to the calculator 5 by the angular sensor 25.

The transmission steps 320 and 330 are carried out in parallel, or simultaneously and synchronously.

During a calculation step 350, a cyclostationarity indicator I_{α} for the temporal vibration signal s(t) is calculated, by applying the method for determining cyclostationarity described above.

The temporal vibration signal s(t) is thus transformed and analysed by applying the steps 140, 170 and 190 of the method for determining cyclostationarity.

Following the calculation step 350 and if the cyclostationarity indicator I_{α} is greater than or equal to the cyclostationarity threshold, a calculation step 370 is carried out by the calculator. At least one monitoring indicator of the mechanical system 10 is then calculated as a function of the temporal vibration signal s(t).

This monitoring indicator may, for example, be calculated as a function of the cyclostationarity indicator I_{α}, or be equal to the cyclostationarity indicator I_{α}. Alternatively, this monitoring indicator may be calculated as a function of the temporal vibration signal s(t) or as a function of the angular vibration signal s(θ).

Finally, during a determination step 390, a risk of presence of a fault in the mechanical system (10) may be determined, by the calculator 5, as a function of a comparison of said at least one monitoring indicator with a fault threshold.

For example, such a risk of presence of a fault in the mechanical system 10 is determined if said at least one monitoring indicator is greater than the fault threshold.

In this case, the mechanical system 10 cannot be considered to be fully functional. The calculator 5 may then transmit an electrical, optical, digital or analog risk alert signal to an alerter during a risk alert step 392, the alerter consequently emitting a risk alert that is, for example, a visual or audio alert, in order to signal the existence of this risk to an operator or pilot of the aircraft 1.

Conversely, if said at least one monitoring indicator is less than or equal to the fault threshold, the mechanical system 10 may be deemed to be functional, no risk of fault in the mechanical system 10 being detected by the monitoring method. The calculator 5 may then be configured to emit an electrical, optical, digital or analog information signal to an alerter, the alerter consequently emitting a no-risk alert 394 that is, for example, a visual or audio alert, in order to indicate to an operator or pilot of the aircraft 1 that the mechanical system 10 is fully functional.

Therefore, the monitoring method according to the disclosure makes it possible to carry out reliable and effective monitoring of the mechanical system 10 in order to detect the possible presence of a fault in the mechanical system 10.

This method for monitoring a mechanical system 10 makes it possible to calculate monitoring indicators solely on the basis of vibration signals comprising a cyclostationary component and therefore likely to comprise signs that at least one fault has occurred. This monitoring method therefore avoids unnecessary calculations of monitoring indicators of the mechanical system 10.

Naturally, the present disclosure is subject to numerous variations as regards its implementation. Although several embodiments are described above, it should readily be understood that it is not conceivable to identify exhaustively all the possible embodiments. It is naturally possible to replace any of the means described with equivalent means without going beyond the ambit of the present disclosure and the claims.

What is claimed is:

1. A method for determining the cyclostationarity of a vibration signal relating to a mechanical system, the mechanical system comprising at least one rotating member that rotates about a rotation axis, at least one vibration sensor transmitting the temporal vibration signal s(t), an angular sensor transmitting a temporal angular signal θ(t) that varies as a function of an angular position of the rotating member about the rotation axis, and a calculator,
the method comprising the following steps:
transforming the temporal vibration signal s(t) into an angular vibration signal s(θ), using the calculator, as a function of the temporal angular signal θ(t);
using the calculator to calculate a normalized cyclostationarity indicator I_{α} using a statistical hypothesis test and as a function of the angular vibration signal s(θ); and
determining that the angular vibration signal s(θ) is cyclostationary when the cyclostationarity indicator I_{α} is greater than or equal to a predetermined cyclostationarity threshold, the predetermined cyclostationarity threshold being between 0 and 1,
for which the method is intended to determine cyclostationarity of order 1, and the statistical hypothesis test is a Student's test applied to an estimate \hat{m}(θ) of a synchronous mean of the angular vibration signal s(θ) in relation to a cyclic period Φ and the calculation of a cyclostationarity indicator I_{α} comprises an intermediate step of determining a statistical indicator η_{α}(θ) calculated according to the following relationship:
$${η}_{α} ( θ ) = {t}_{α}^{K - 1} . \frac{\hat{σ} ( θ )}{\sqrt{K}} ,$$
wherein t_{α}^{K-1} is half of a confidence interval associated with the Student's test with K−1 degrees of freedom with a risk 1α;
\hat{σ}(θ) is an estimate of the standard deviation of the angular vibration signal s(θ) corresponding to a normal distribution for an angle θ defined such that
$$\hat{σ} ( θ ) = \sqrt{( θ ) . \frac{K}{K - 1}} ;$$
θ is the angular position of the rotating member about the rotation axis; [symbol]
(θ) is an estimate of the synchronous variance of the angular vibration signal s(θ) in relation to the cyclic period Φ, such that
$$( θ ) = \frac{1}{K} {{\sum }_{i = 0}^{K - 1} [ \hat{r} ( θ + i . Φ ) ]}^{2} ;$$
\hat{r}(θ) is an estimate of a residual of the angular vibration signal s(θ) such that \hat{r}(θ)=s(θ)−\hat{m}(θ);
\hat{m}(θ) is the estimate of the synchronous mean in relation to the cyclic period Φ such that
$$\hat{m} ( θ ) = \frac{1}{K} {\sum }_{i = 0}^{K - 1} s ( θ + i . Φ ) ;$$
\sqrt{ } is the square root function;
Σ is the sum function;
Φ is the cyclic period of the angular vibration signal s(θ);
K is a number of cycles such that
$$K = \frac{N}{Φ} ;$$
N is a number of sampling points forming the angular vibration signal s(θ); and
i is an integer varying from 0 to (K−1).

2. The method according to claim 1,
for which the cyclostationarity indicator I_{α} is calculated using the following relationship:
$${I}_{α} = \frac{{\sum }_{θ} ( \vert \hat{m} ( θ ) \vert . {𝒥}_{Cyc} ( θ ) )}{{\sum }_{θ} \vert \hat{m} ( θ ) \vert} ,$$
wherein [symbol] _{Cyc}(θ) is an indicator function of the cyclostationarity of the angular vibration signal s(θ) that is equal to 1 if \hat{m}(θ)>η_{α}(θ) and equal to 0 if \hat{m}(θ)≤η_{α}(θ); and
∥ is the absolute value function.

3. The method for determining the cyclostationarity of a vibration signal relating to a mechanical system, the mechanical system comprising at least one rotating member that rotates about a rotation axis, at least one vibration sensor transmitting the temporal vibration signal s(t), an angular sensor transmitting a temporal angular signal θ(t) that varies as a function of an angular position of the rotating member about the rotation axis, and a calculator,
the method comprising the following steps:
transforming the temporal vibration signal s(t) into an angular vibration signal s(θ), using the calculator, as a function of the temporal angular signal θ(t);
using the calculator to calculate a normalized cyclostationarity indicator I_{α} using a statistical hypothesis test and as a function of the angular vibration signal s(θ); and
determining that the angular vibration signal s(θ) is cyclostationary when the cyclostationarity indicator I_{α} is greater than or equal to a predetermined cyclostationarity threshold, the predetermined cyclostationarity threshold being between 0 and 1,
for which the method is intended to determine cyclostationarity of order 2 and the statistical hypothesis test is Bartlett's test applied to an estimate [symbol] of a synchronous variance of the angular vibration signal s(θ) in relation to a cyclic period Φ and the cyclostationarity indicator I_{α} is calculated according to the following relationship:
$${I}_{α} = exp ( - \frac{{x}_{α}^{2}}{ψ} ) ,$$
wherein exp is the exponential mathematical function;
ψ is a scalar determined as a function of the estimate [symbol] of the synchronous variance such that:
$$ψ = \frac{3 N . ( K - 1 ) . [ ln ( {\sum }_{n = 1}^{N} ( {θ}_{n} ) / N ) - {\sum }_{n = 1}^{N} ln ( ( {θ}_{n} ) ) / N ]}{3 N . ( K - 1 ) + N + 1} ;$$ [symbol]
(θ) is the estimate of the synchronous variance in relation to the cyclic period Φ, such that
$$( θ ) = \frac{1}{K} {{\sum }_{i = 0}^{K - 1} [ \hat{r} ( θ + i . Φ ) ]}^{2} ;$$
\hat{r}(θ) is an estimate of a residual of the angular vibration signal s(θ) such that \hat{r}(θ)=s(θ)−\hat{m}(θ);
\hat{m}(θ) is an estimate of the synchronous mean of the angular vibration signal s(θ) in relation to the cyclic period Φ, such that
$$\hat{m} ( θ ) = \frac{1}{K} {\sum }_{i = 0}^{K - 1} s ( θ + i . Φ ) ;$$
Σ is the sum function;
θ is the angular position of the rotating member about the rotation axis;
Φ is the cyclic period of the angular vibration signal s(θ);
K is a number of cycles such that
$$K = \frac{N}{Φ} ;$$
N is a number of sampling points forming the angular vibration signal s(θ);
i is an integer varying from 0 to (K−1);
ln is the natural logarithm function; and [symbol]
_{α}² is a confidence interval associated with a chi-squared distribution with (N−1) degrees of freedom with a risk 1−α.

4. The method according to claim 1,
for which the method comprises at least one of the following additional steps:
generating a cyclostationarity alert when the cyclostationarity indicator I_{α} is greater than or equal to the cyclostationarity threshold; and
generating a non-cyclostationarity alert when the cyclostationarity indicator I_{α} is less than the cyclostationarity threshold.

5. An arrangement method for arranging at least one vibration sensor dedicated to monitoring a mechanical system, the mechanical system comprising at least one rotating member that rotates about a rotation axis, at least one vibration sensor, an angular sensor, and a calculator,
the arrangement method comprising the following steps carried out over at least two successive iterations:
positioning and orienting the vibration sensor (s) on the mechanical system, the vibration sensor (s) being situated in a different position and/or orientation at each iteration;
transmitting a temporal vibration signal s(t) by means of the vibration sensor (s), for different operating modes of the mechanical system;
transmitting a temporal angular signal θ(t), by means of the angular sensor, that varies as a function of an angular position of the rotating member about the rotation axis for the different operating modes of the mechanical system; and
calculating a cyclostationarity indicator I_{α} relative to the temporal vibration signal s(t) for the different operating modes of the mechanical system, by applying the method for determining cyclostationarity according to claim 1,
the arrangement method also comprising a step of validating the position and the orientation of the vibration sensor (s) on the mechanical system, wherein the position and the orientation of the vibration sensor(s) are validated if a characteristic value of the cyclostationarity indicators I_{α} relating to the position and the orientation for the different operating modes of the mechanical system is greater than a validation threshold, the characteristic value being chosen from a median value of the cyclostationarity indicators I_{α}, an arithmetic mean of the cyclostationarity indicators I_{α} or a root mean square of the cyclostationarity indicators I_{α}.

6. The method according to claim 5,
for which, during the validation step, the position and the orientation of the vibration sensor (s) are validated if a difference between a maximum value and a minimum value of the cyclostationarity indicators I_{α} relating to the position and the orientation is also less than a difference threshold.

7. The method according to claim 6,
for which the difference threshold is equal to a percentage of the characteristic value of the cyclostationarity indicators I_{α}.

8. The method according to claim 5,
for which the different operating modes of the mechanical system comprise only stabilized operating modes and do not comprise transient operating modes.

9. The method for monitoring a mechanical system, the mechanical system comprising at least one rotating member that rotates about a rotation axis, at least one vibration sensor transmitting one temporal vibration signal x(t), an angular sensor transmitting a temporal angular signal θ(t) that varies as a function of an angular position of the rotating member about the rotation axis, and a calculator,
the method comprising the following steps:
transmitting the temporal vibration signal s(t) by means of the vibration sensor (s);
transmitting the temporal angular signal θ(t) by means of the angular sensor;
calculating a cyclostationarity indicator I_{α} for the temporal vibration signal s(t), by applying the method for determining cyclostationarity according to claim 1;
if the cyclostationarity indicator I_{α} is greater than or equal to the cyclostationarity threshold, calculating at least one monitoring indicator of the mechanical system, with the calculator, as a function of the temporal vibration signal s(t); and
determining the presence of a fault in the mechanical system by comparing the monitoring indicator (s) with a fault threshold.

10. The method according to claim 9,
for which the presence of a fault in the mechanical system is determined if the monitoring indicator (s) is/are greater than the fault threshold.

11. The method according to claim 9,
for which the monitoring indicator (s) comprise (s) the cyclostationarity indicator I_{α} or is calculated as a function of the cyclostationarity indicator I_{α}.

12. A device for determining cyclostationarity for validating whether a temporal vibration signal x(t) relating to a mechanical system is cyclostationary, the validation device being configured for a mechanical system comprising at least one rotating member that rotates about a rotation axis and at least one vibration sensor transmitting the temporal vibration signal s(t), the device for determining cyclostationarity comprising an angular sensor transmitting a temporal angular signal θ(t) that varies as a function of an angular position of the rotating member about the rotation axis, and a calculator,
wherein the device for determining cyclostationarity is configured to implement the method according to claim 1.

13. A device for arranging at least one vibration sensor dedicated to monitoring a mechanical system, the mechanical system comprising at least one rotating member that rotates about a rotation axis, at least one vibration sensor, the arrangement device comprising an angular sensor transmitting a temporal angular signal θ(t) that varies as a function of an angular position of the rotating member about the rotation axis, and a calculator,
wherein the arrangement device is configured to implement, over at least two successive iterations, the steps of transmitting a temporal vibration signal s(t) by means of the vibration sensor (s) for different operating modes of the mechanical system, of transmitting a temporal angular signal θ(t) by means of the angular sensor, and of calculating a cyclostationarity indicator I_{α} relative to the temporal vibration signal s(t) for the different operating modes of the mechanical system of the method according to claim 5, the at least one vibration sensor is located at a different position and/or orientation at each iteration, the arrangement device being next configured to implement the step of validating the position and the orientation of the vibration sensor (s) on the mechanical system.

14. A monitoring device for monitoring a mechanical system, the monitoring device being configured to monitor a mechanical system comprising at least one rotating member that rotates about a rotation axis, the monitoring device comprising at least one vibration sensor transmitting a temporal vibration signal s(t), an angular sensor transmitting a temporal angular signal θ(t) that varies as a function of an angular position of the rotating member about the rotation axis, and a calculator,
wherein the monitoring device is configured to implement the method according to claim 9.

15. A mechanical system comprising at least one rotating member that rotates about a rotation axis,
wherein the mechanical system comprises the monitoring device according to claim 14.

16. A gearbox comprising the mechanical system according to claim 15.
